(19) United States
(12) Patent Application Publication
(10) Pub. No.: US 2016/0126789 A1
(43) Pub. Date: May 5, 2016

(54) PERMANENT MAGNET MOTOR

(71) Applicant: GM GLOBAL TECHNOLOGY OPERATIONS LLC, Detroit, MI (US)

(72) Inventors: Mohammad Faizul Momen, Rochester Hills, MI (US); Khwaja M. Rahman, Troy, MI (US)

(21) Appl. No.: 14/529,684

(22) Filed: Oct. 31, 2014

(51) Int. Cl. H02K 1/16; H02K 1/27

(52) U.S. Cl. CPC H02K 1/165; H02K 1/274

(57) ABSTRACT

A permanent magnet (PM) motor includes a stator defining an inner stator opening. The inner stator opening extends along a stator axis. The PM motor further includes a rotor disposed inside the stator. The stator includes a plurality of lamination segments stacked together along the stator axis. Each lamination segment includes an annular stator body and teeth extending from the annular stator body toward the stator axis. The teeth are spaced apart from one another so as to define a plurality of slots arranged annularly about the stator axis. The stator defines slot openings arranged annularly about the stator axis. At least one of the lamination segments is rotationally offset relative to another lamination segments so that at least one of the slot openings is circumferentially offset from another slot openings in the other lamination segment.

### TECHNICAL FIELD

The present disclosure relates to a permanent magnet motor.

### BACKGROUND

Electric motors, such as those typically used in hybrid electromechanical powertrains for automotive vehicles, have a rotor and a stator surrounding the rotor. The rotor can rotate relative to the stator, and the stator is fixed to a stationary member, such as a transmission housing or casing. An air gap is established by the radial clearance between the rotor and the stator.

### SUMMARY

It is useful to minimize the torque ripple and the radial force in a permanent magnet (PM) motor in order to maximize its efficiency and minimize the noise, vibration, and harshness (NVH) during operation. In the present disclosure, “torque ripple” refers to a periodic increase or decrease in output torque in electric motors. The design of the presently disclosed PM motor minimizes the torque ripple and the radial force during operation, thereby maximizing efficiency.

In an embodiment, the presently disclosed PM motor includes a stator defining an inner stator opening. The inner stator opening extends along a stator axis. The PM motor further includes a rotor disposed inside the stator. The rotor can rotate about the stator axis relative to the stator. The stator includes a plurality of lamination segments stacked together along the stator axis. Each lamination segment includes an annular stator body and teeth extending from the annular stator body toward the stator axis. The annular stator body is commonly referred to as the back iron. The teeth are spaced apart from one another so as to define a plurality of slots annularly arranged about the stator axis. Each slot is defined between two teeth. The stator defines slot openings annularly arranged about the stator axis. At least one of the lamination segments is rotationally offset relative to another lamination segments so that at least one of the slot openings is circumferentially offset from another slot openings in the other lamination segment.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic cross-sectional front view of a PM motor, which is part of a vehicle;

FIG. 2 is a schematic perspective view of a stator of the PM motor;

FIG. 3 is a schematic fragmentary, front view of a lamination segment of the stator;

FIG. 4 is a schematic fragmentary, side view of the stator viewed from its center; and

FIG. 5 is a schematic fragmentary, side view of the stator, taken around section 5 of FIG. 4.

### DETAILED DESCRIPTION

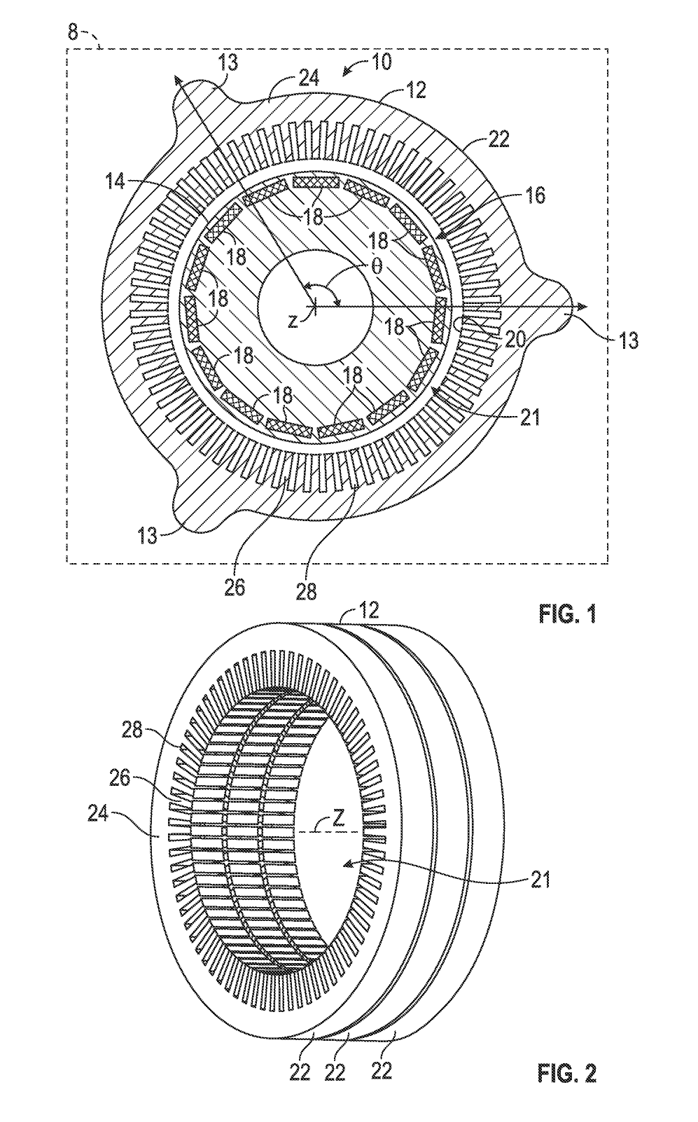

Referring to the drawings, wherein like reference numbers correspond to like or similar components throughout the several figures, and beginning with FIG. 1, a permanent magnet (PM) motor 10 may be part of a vehicle 8, such as car, and can convert electrical energy into mechanical energy (e.g., in the form of torque). The PM motor 10 can be used to propel the vehicle 8, which may be an automotive or non-automotive vehicle. For example, the vehicle 8 may be a truck or a boat.

In the depicted embodiment, the PM motor 10 includes a stator 12 and a rotor 14 disposed within the stator 12 and can be configured as an interior permanent magnet motor. When the PM motor 10 receives electrical energy from a power supply, the rotor 14 can rotate relative to the stator 12 in order to propel the vehicle 8. An air gap 16 is defined between the stator 12 and the rotor 14. The rotor 14 may have a substantially annular shape and includes a plurality of permanent magnets 18. The stator 12 may also have a substantially annular shape and defines an inner stator opening 21 configured, shaped, and sized to receive the rotor 14. The inner stator opening 21 extends along a stator axis Z (see also FIG. 2). The rotor 14 can rotate about the stator axis Z relative to the stator 12 when the PM motor 10 receives electrical energy from a power supply.

With reference to FIGS. 1 and 2, the stator 12 includes a plurality of lamination segments 22 stacked together along the stator axis Z. Each lamination segment 22 includes an annular stator body 24 (i.e., the back iron) and a plurality of teeth 26 extending from the annular stator body 24 toward the stator axis Z. The teeth 26 are arranged annularly around the stator axis Z. Further, the teeth 26 are spaced apart from each other so as to define a plurality of slots 28 arranged annularly about the stator axis Z. Each tooth 26 includes a tooth tip 20. Each slot 28 is defined between two teeth 26. The stator 12 further includes a plurality of mounting tabs 13 extending outwardly from the annular stator body 24. The mounting tabs 13 can be used to couple the stator 12 to a stationary casing.

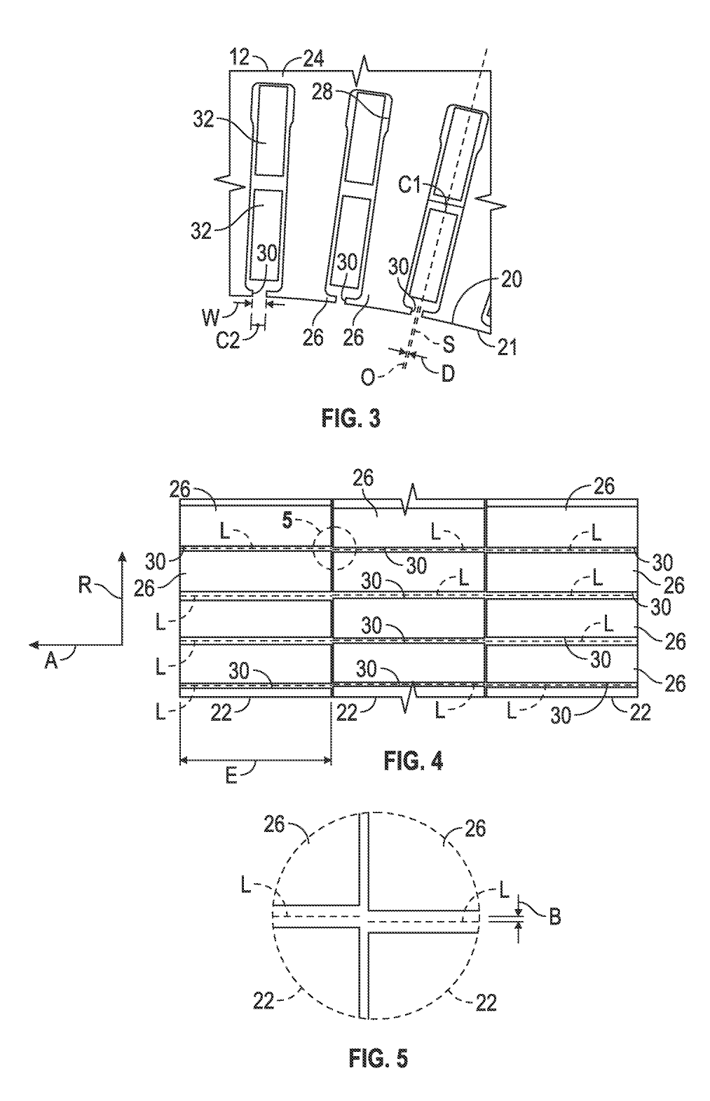

With reference to FIG. 3, each slot 28 is configured, shaped, and sized to receive at least one electrical conductor 32, such as a winding. Each slot 28 extends along a slot central axis S. The slot central axis S extends through the center C1 of the slot 28 along a radial direction. The electrical conductors 32 are disposed in the slots 28 and are electrically connected to a drive (e.g. an inverter connected to a battery) in order to receive electrical energy. Upon receipt of electrical energy, the electrical conductors 32 magnetize the stator core (stator iron) and the latter interacts with the permanent magnets 18, thereby causing the rotor 14 to rotate relative to the stator 12. When the supply of electrical energy to the electrical conductors 32 ceases, the magnetic interaction between the permanent magnets 18 of the rotor 14 and the stator 12 ends, thereby causing the rotor 14 to reduce its speed.

The stator 12 further defines a plurality of slot openings 30 arranged annularly about the stator axis Z (FIG. 2). The slots 28 separate the teeth 26. Each slot opening 30 is connected to one of the slots 28 and has slot opening width W. The slot opening widths W may not be the same for all the slots openings 30. For example, all the slot openings 30 may have different slot opening widths W. Alternatively, the slot opening width W of some slot openings 30 may be the same while others may be different. It is also envisioned that all the slot openings 30 may have the same slot opening width W. The slots 28 of all the lamination segments 22 are axially aligned along the axial direction A (FIG. 4).

In addition, each slot opening 30 has a center C2 in the middle of the slot opening width W. An opening central axis O extends along the slot opening 30 in the radial direction and intersects the center C2 of the slot opening 30. All or some of the slot openings 30 may be circumferentially offset from the slot central axis S in order to minimize torque ripple. In other words, the center C2 of the slot opening 30 may be circumferentially offset from the center C1 of the slot 28 by an opening offset distance D. The circumferential opening offset distance D is defined from the opening central axis O to the slot central axis S. Each of the slot 28 and slot opening 30 combinations (i.e., the slot/opening combination) may have a different opening offset distance D. The slot 28 and slot opening 30 combination refers to the slot 28 and the slot opening 30 that are in communication with each other. Some slots 28 and slot openings 30 combinations may have the same offset distances D. It is also contemplated that all the slots 28 and slot openings 30 may not be circumferentially offset relative to one another. At least two of the slot/opening combinations have different circumferential offset distances B.

With reference to FIGS. 4 and 5, at least one of the lamination segments 22 is circumferentially offset relative to another lamination segment 22 so that at least one of the slot openings 30 is axially misaligned relative to another slot opening 30 along an axial direction A in order to minimize the torque ripple and the radial force during operation of the PM motor 10. Minimizing the torque ripple and the radial force can help maximize the efficiency of the PM motor 10 and minimize the noise, vibration, and harshness. During assembly of the stator 12, at least one of the lamination segments 22 can be rotated relative to another lamination segment 22 by an angle of rotation θ defined between the mounting tab 13 (FIG. 1) of one lamination segment 22 and another mounting tab 13 of another lamination segment 22. The angle of rotation θ can be 360÷n for every 1/n lamination segment, wherein n may be three (3), four (4), or some other number.

With reference to FIGS. 4 and 5, each slot opening 30 extends axially along an opening longitudinal axis L. Each opening longitudinal axis L extends along the axial direction A. Further, each opening longitudinal axis L may be parallel to the stator axis Z (FIG. 2) and extends along the length E of each slot opening 30. Because the slot openings 30 are axially misaligned to one another, the opening longitudinal axes L of different slot openings 30 can be spaced by a circumferential offset distance B. All or some of the opening longitudinal axes L can be spaced from at least another opening longitudinal axis L by the circumferential offset distance B. The circumferential offset distance B between adjacent slot openings 30 can be different or the same for each lamination segment 22. For example, a first lamination segment 22 can be rotationally offset to a second lamination segment 22 so that the opening longitudinal axis L of one slot opening 30 in the first lamination segment 22 is circumferentially offset from another slot opening 30 in the second lamination segment 22 by the circumferential offset distance B.

The PM motor 10 can be manufactured by first stacking and aligning all the lamination segments 22 so that the stator openings 30 of each lamination segment 22 are substantially aligned with one another along the axial direction A. Then, at least one of the lamination segments 22 is rotated relative to another lamination segment 22 about the stator axis Z in order to misalign at least some of the slot openings 30 along the axial direction A. At this juncture, one of the lamination segments 22 is rotationally offset from at least one other lamination segment 22 such that at least one of the slot openings 30 of one lamination segment 22 is axially misaligned relative to the slot opening 30 of another lamination segment 22. Next, the stacked lamination segments 22 are coupled to one another. For instance, the lamination segments 22 may be glued together.

While the best modes for carrying out the teachings have been described in detail, those familiar with the art to which this disclosure relates will recognize various alternative designs and embodiments for practicing the teachings within the scope of the appended claims.

1. A permanent magnet (PM) motor, comprising:
a stator defining an inner stator opening, the inner stator opening extending along a stator axis in an axial direction;
a rotor disposed inside the stator, wherein the rotor is rotatable about the stator axis relative to the stator; and
wherein the stator includes:
a plurality of lamination segments stacked together along the stator axis, each of the lamination segments including:
an annular stator body;
a plurality of teeth extending from the annular stator body toward the stator axis, wherein the plurality of teeth are spaced apart from one another so as to define a plurality of slots arranged annularly about the stator axis, each of the slots is defined between two of the teeth, the stator defining a plurality of slot openings arranged annularly about the stator axis, each of the slot openings is in communication with one of the slots so as to define a slot/opening combination, and each of the slot openings extends along an opening longitudinal axis in the axial direction;
wherein each of the slots extends along a slot central axis, each slot central axis extends through a center of one of the slots in a radial direction, each of the slot openings extends along an opening central axis in the radial direction, each opening central axis extends through a center of one of the slot openings along the radial direction;
wherein, in at least one slot/opening combination, and the slot central axis of one of the slots is circumferentially offset from the opening central axis of one of the slot openings in the slot/opening combination by a circumferential opening offset distance; and
wherein a first lamination segment of the plurality of lamination segments is rotationally offset relative to a second lamination segment of the plurality of lamination segments so that the opening longitudinal axis of at least one of the slot openings in the first lamination segment is circumferentially offset from the opening longitudinal axis of at least one of the slot openings in the second lamination segment by a circumferential offset distance.

2. The PM motor of claim 1, wherein each of the slot openings has a slot opening width, and the slot opening width of at least one of the slot openings is different from the slot opening width of at least one other slot opening.

3. The PM motor of claim 1, wherein each slot defines a center, each slot opening defines a center, and the center of at least one of the slot openings is circumferentially offset from the center of at least one of the slots in the slot/opening combination.

4. The PM motor of claim 1, wherein the circumferential opening offset distance in one slot/opening combination may be different from the circumferential opening offset distance in another slot/opening combination.

5. The PM motor of claim 1, wherein the slots in one of the lamination segments are axially aligned with the slots in another of the lamination segments.

6. The PM motor of claim 1, wherein at least one of the slot openings in the first lamination segment is circumferentially offset from the opening longitudinal axis of at least one of the slot openings in the second lamination segment by a circumferential offset distance.

7. The PM motor of claim 1, wherein the opening longitudinal axis is parallel to the stator axis.

8. The PM motor of claim 1, further comprising a plurality of electrical conductors each disposed in one of the slots.

9. The PM motor of claim 8, wherein the rotor includes a plurality of permanent magnets.

10. A vehicle, comprising:
a permanent magnet (PM) motor configured to propel the vehicle, wherein the PM motor includes:
a stator defining an inner stator opening, the inner stator opening extending along a stator axis in an axial direction;
a rotor disposed inside the stator, wherein the rotor is rotatable about the stator axis relative to the stator; and
wherein the stator includes:
a plurality of lamination segments stacked together along the stator axis, each of the lamination segments including:
an annular stator body;
a plurality of teeth extending from the annular stator body toward the stator axis, wherein the plurality of teeth are spaced apart from one another so as to define a plurality of slots arranged annularly about the stator axis, each of the slots is defined between two of the teeth, the stator defining a plurality of slot openings arranged annularly about the stator axis, each of the slot openings is in communication with one of the slots so as to define a slot/opening combination, and each of the slot openings extends along an opening longitudinal axis in the axial direction;
wherein each of the slots extends along a slot central axis, each slot central axis extends through a center of one of the slots in a radial direction, each of the slot openings extends along an opening central axis in the radial direction, each opening central axis extends through a center of one of the slot openings along the radial direction;
wherein, in at least one slot/opening combination, and the slot central axis of one of the slots is circumferentially offset from the opening central axis of one of the slot openings in the slot/opening combination by a circumferential opening offset distance; and
wherein a first lamination segment of the plurality of lamination segments is rotationally offset relative to a second lamination segment of the plurality of lamination segments so that the opening longitudinal axis of at least one of the slot openings in the first lamination segment is circumferentially offset from the opening longitudinal axis of at least one of the slot openings in the second lamination segment by a circumferential offset distance.

11. The vehicle of claim 10, wherein each of the slot openings has a slot opening width, and the slot opening width of at least one of the slot openings is different from the slot opening width of at least one other slot opening.

12. The vehicle of claim 10, wherein each slot defines a center, each slot opening defines a center, and the center of at least one of the slot openings is circumferentially offset from the center of at least one of the slots in the slot/opening combination.

13. The vehicle of claim 12, wherein each slot defines a center, each slot opening defines a center, and the center of at least one of the slot openings is circumferentially offset from the center of at least one of the slots in the slot/opening combination.

14. The vehicle of claim 13, wherein the opening offset distance in one slot/opening combination may be different from the opening offset distance in another slot/opening combination.

15. The vehicle of claim 10, wherein the slot openings in one of the lamination segments are misaligned relative to the slot openings in another of the lamination segments.

16. The vehicle of claim 10, wherein opening longitudinal axis is parallel to the stator axis.

17. The vehicle of claim 10, further comprising a plurality of electrical conductors each disposed in one of the slots.

18. The vehicle claim 17, wherein the rotor includes a plurality of permanent magnets.
